(19) United States
(12) Patent Application Publication
(10) Pub. No.: US 2014/0013205 A1
(43) Pub. Date: Jan. 9, 2014

(54) METHODS FOR MATCHING XML DOCUMENTS

(71) Applicant: THE GOVERNORS OF THE UNIVERSITY OF ALBERTA, Edmonton (CA)

(72) Inventors: Rimon MIKHAIEL, Edmonton (CA); Eleni STROULIA, Edmonton (CA)

(73) Assignee: THE GOVERNORS OF THE UNIVERSITY OF ALBERTA, Edmonton (CA)

(21) Appl. No.: 13/930,688

(22) Filed: Jun. 28, 2013

Related U.S. Application Data
(60) Provisional application No. 61/666,108, filed on Jun. 29, 2012.

(30) Foreign Application Priority Data
Jun. 29, 2012 (CA) 2782391

(51) Int. Cl. G06F 17/22

(52) U.S. Cl. CPC G06F 17/2247
USPC 715/234

(57) ABSTRACT

Methods, systems, and devices related to determining differences between XML documents. Two XML documents to be compared are first each decomposed into ordered labelled trees. Sets of operations which convert one tree into the other tree are then determined and a cost function is applied to each set of operations. The set of operations with the lowest cost is then selected. The cost function uses an affine-cost policy which adjusts a cost of each operation based a context in which the operation is applied.

### TECHNICAL FIELD

The present invention is a non-provisional application of U.S. Provisional Application No. 61/666,108 filed Jun. 29, 2012.

The present invention relates to document analysis. More specifically, the present invention relates to methods, systems, and devices relating to determining differences between two XML documents.

### BACKGROUND OF THE INVENTION

XML, the Extensible Markup Language, is the universal format for structured documents and data exchange on the World Wide Web. XML documents include embedded metadata that represent their logical and semantic structure and partially describe the behavior of computer programs that process them. XML was conceived as a subset of Standard Generalized Markup Language (SGML), and was originally designed to facilitate the interoperability between SGML and Hypertext Markup Language (HTML]. XML has now become the standard exchange format for modern Information Systems, and has been described as “the lingua franca for information interchange, and will perhaps even surpass unstructured text someday”.

Many different types of data formats, specification languages, and interaction protocols are represented in XML. For example, XML is the de facto language for Service Oriented Architecture (SOA) technologies such as Universal Description Discovery and Integration (UDDI), Simple Object Access Protocol (SOAP), Web Service Description Language (WSDL), Business Process Execution Language (BPEL), Web Ontology Language for Services (OWL-S), Electronic Business using XML (ebXML) and Service Modeling Language (SML). XML is also the standard representation for Semantic Web technologies such as OWL and RDF. XML, nevertheless, has become the standard artifact data format in many other applications such as Open Office documents, SVG drawings, and XHTML documents, XSL, databases, Open Office Format (OPF), and Open Office XML. Additionally, XML is the standard exchange format for modeling metadata languages such as XML Metadata Interchange (XMI).

In each of these domains one encounters instances of differencing problems in the context of different activities. For example, XML document differencing is very important for document management functions that include change detection and tracking, and version merging. A differencing problem sometimes is also called a comparison problem, or a matching problem. For example, in SOA, differencing is necessary for service discovery and for matching a requested service against a repository of advertised services, based on WSDL Matching, BPEL Matching, or OWL-S Matching. Differencing is also necessary in SOA, for the purpose of automatic composition and integration of different services, in addition to helping in the migration from one version to another, or from one service provider to another. In the world of the Semantic Web, differencing plays a key role in the problem of ontology matching, which is essential for setting translation bases between vendors talking in terms of different ontologies. Differencing is also a fundamental task in matching models such as Unified Modeling Language (UML). The latter is important for monitoring and tracking evolutions occurring to a certain model, or finding the proper mapping between elements of different models. HTML differencing is necessary for automatic information extraction from the Web in order to be structured in an easy to process format or even to automatically generate RSS feeds from sites of interest.

In most of the aforementioned application domains, special-purpose methods have been developed to solve the differencing problem for these domains in particular. These methods have been both expensive to build and hard to reuse. Other differencing methods rely on abstract syntactic representation and are not tied to a certain application domain. These methods are usually incapable of capturing domain knowledge and semantics, and consequently, are not able to produce results that are acceptable to subject-matter experts. The problem then becomes the development of a general method for comparing XML documents for application to all of these domains while ensuring that the method is aware of the domain-specific semantics, such that the reported differences correspond to domain benchmarks.

The problem of XML differencing has been studied in the context of many application domains. Differencing methods can be divided into two broad categories: general XML differencing and domain-specific differencing. The approaches in the former category aim to be so generic that they can compare any kind of XML document regardless of the underlying application domain. The approaches in the latter category are aware of the knowledge and semantics of the underlying domains, and are built to serve such domains in particular.

XML differencing is defined as the process of finding proper mapping between elements of the two documents in order to detect changes, deletions, and insertions. The input consists of two XML documents, and optionally the Document Type Definitions (DTDs) or XSDs to which they conform. The output is an edit script that can transform one document into the other, in conjunction with a similarity measure between the two documents, called edit-distance.

XML-document differencing is necessary for version management functions such as change detection and tracking, version merging, indexing, and answering temporal queries. Some applications have the luxury of recording the changes as they happen through the XML document editor, or an Integrated Development Environment (IDE), which is then utilized to produce the differencing results. However, a general XML differencing method should not rely on the assumption that editing and changes happen through a certain editing utility, or that the edit operations are consistently recorded as they happen.

There is therefore a need for methods, devices, and systems which can mitigate if not overcome the shortcomings of the prior art.

### SUMMARY OF INVENTION

The present invention provides methods, systems, and devices related to determining differences between XML documents. Given two XML documents to be compared, each document is first transformed into two corresponding ordered labelled trees. The trees will have nodes corresponding to XML elements, with one set of edges corresponding to the containment relations between XML elements and a second set of edges corresponding to the reference relations between XML elements, introduced through the ID and REF attributes. Sets of operations which convert one tree into the other tree are then determined and a cost function is applied to each set of operations. The set of operations with the lowest cost is then selected. The cost function uses an affine-cost policy which adjusts a cost of each operation based a context in which the operation is applied.

In a first aspect, the present invention provides a method for determining differences between a first document and a second document, the method comprising:
a) decomposing said first document into an ordered labeled tree to result in a first tree;
b) decomposing said second document into an ordered labeled tree to result in a second tree;
c) determining at least one set of operations which, when executed, converts said first tree into said second tree;
d) providing a cost function for operations used in step c);
e) selecting a set of operations from step c) such that a cost to convert said first tree into said second tree is minimized.

In a second aspect, the present invention provides computer readable media having encoded thereon computer readable and computer executable instructions which, when executed implements a method for determining differences between a first document and a second document, the method comprising:
a) decomposing said first document into an ordered labeled tree to result in a first tree;
b) decomposing said second document into an ordered labeled tree to result in a second tree;
c) determining at least one set of operations which, when executed, converts said first tree into said second tree;
d) providing a cost function for operations used in step c);
e) selecting a set of operations from step c) such that a cost to convert said first tree into said second tree is minimized.

### BRIEF DESCRIPTION OF THE DRAWINGS

The embodiments of the present invention will now be described by reference to the following figures, in which identical reference numerals in different figures indicate identical elements and in which:

FIG. 1 illustrates a number of tree-edit operations;

FIGS. 2A and 2B schematically illustrate two functions used by the invention;

FIG. 3 is a block diagram of the inputs and outputs of one aspect of the invention;

FIG. 4 illustrates the bootstrapping process that the invention undergoes for each new domain.

FIG. 5 shows two possibilities of matching two strings;

FIG. 6A-6C show insertion and deletion operations and are used to illustrate the importance of an affine-cost function;

FIG. 7A-7D illustrate various potential matching solutions and are used to show optimal edit scripts;

FIG. 8 is a visualization of the ontology described by code in the description;

FIG. 9A-9D show two ontologies and potential solutions for matching these two ontologies and are used to show the importance of an affine-cost policy;

FIG. 10A-10D also show two ontologies and potential matching solutions and are used to illustrate the importance of reference structure when matching ontologies;

FIG. 11 is a table showing the configuration necessary to customize the invention for different domains; and

FIG. 12 is a flowchart detailing the steps in a method according to one aspect of the invention.

### DETAILED DESCRIPTION OF THE INVENTION

By nature an XML document can be represented as an ordered labeled tree in a very similar manner to a Document Object Model (DOM) representation of an XML document. In that sense, the XML differencing problem can be formulated as a tree-to-tree correction problem where the objective is to find the cheapest (i.e. most optimal) script of edit operations such as change, deletion, and insertion that transform or convert one tree into the other.

Given two trees, tree-edit distance is the minimum cost sequence of edit-operations that transforms one tree into the other.

For clarity, the following definitions and notations will be used in this document. Let T be a rooted tree, then:
Ordered tree: a tree T is called an ordered tree if a left-to-right order among siblings in T is given.
Node index: nodes are numbered in a post-order manner where children are visited from left-to-right before their parents. In other words, the index of the root node should be the same as the size of the tree that is denoted as |T|. Hence, T[x₁ . . . x₂] refers to the set of nodes with indexes between x₁ and x₂ inclusive. The left most leaf child of a node xᵢ can be obtained by lm(xᵢ). Hence, the sub-tree rooted by node xᵢ can be represented as T[lm(xᵢ) . . . xᵢ] that is short-handed as T[xᵢ], and the whole tree can similarly be represented as T[|T|].
Node label: the label of a node xᵢ is denoted by l(xᵢ).
Labeled tree: a rooted tree T is called a labeled tree if each node v is assigned a symbol from an alphabet Σ.
Edit operations: an edit operation sᵢ is represented as (xᵢ, yᵢ) where xᵢ is either a node in Tᵢ where 1<xᵢ<|Tₗ|, or is λ in case of no correspondence in Tₗ, and similarly yᵢ is either a node in T₂ where 1<yᵢ<|T₂|, or is λ in case of no correspondence in T₂. Hence, edit operations can be formally described as follows:
   Change operation: denoted as (xᵢ, yᵢ) where l₁ (xᵢ) the label of node xᵢ is mapped to l₂(yᵢ). If l₁(xᵢ)=l₂(yᵢ), it is pronounced as a match rather than as a change operation.
   Deletion Operation: denoted as (xᵢ, λ) and means that node xᵢ with label l₁ (xᵢ) in T₁ has no correspondence in T₂.
   Insertion Operation: denoted as (λ, yᵢ) and means that node yᵢ with label l₂(yᵢ) in T₂ has no correspondence in T₁.

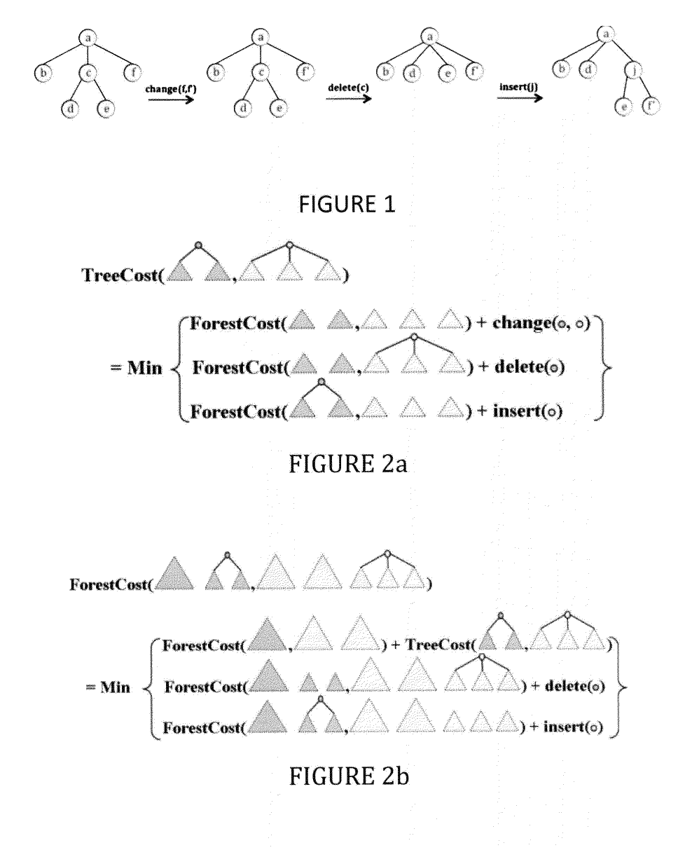

FIG. 1 illustrates the tree-edit operations: (1) operation change label of node f to be f′, (2) operation delete node c where its children {d, e} became children of its parent, i.e. node a, and (3) operation insert a new node j to become an intermediate parent of some of node a children. It is very important to mention that an insertion operation is just the inverse of a deletion operation. The same operation when applied to the first tree, it is called a deletion but when applied to the second tree, it is called an insertion. Additionally, in a change operation, if the labels are the same, then it is not called a change but rather match operation.
Edit script: an edit script is represented as Sᵢ=sᵢ₁, . . . , sᵢₖ where Sᵢ is the i^{th} edit script that is composed of a sequence of k edit operations, and that is capable of transforming T₁ into T₂. An edit operation sᵢⱼ denotes the j^{th} edit operation of the i^{th} edit script, and is represented as either a matching operation (xᵢⱼ,yᵢⱼ) such that xᵢⱼ and yᵢⱼ are nodes in T₁ into T₂ respectively, a delete operation (xᵢⱼ, λ), or an insert operation (λ, yᵢ) that satisfy the following conditions such as (xᵢⱼ_{₁},yᵢⱼ_{₁}) and (xᵢⱼ_{₂},yᵢⱼ_{₂}) are in Sᵢ:
   xᵢⱼ_{₁}=xᵢⱼ_{₂} [symbol] *yᵢⱼ_{₁}=yᵢⱼ_{₂} (one-to-one condition; no merge or split allowed).
   xᵢⱼ_{₁} is an ancestor of xᵢⱼ_{₂} [symbol] yᵢⱼ_{₁} is an ancestor of yᵢⱼ_{₂} (structure preserving condition).
   xᵢⱼ_{₁} is to the left of xᵢⱼ_{₂} [symbol] yᵢⱼ_{₁} to the left of yᵢⱼ_{₂} (order preserving condition).
Tree-edit distance: assume that given a cost function γ defined on each edit operation sᵢ, and is denoted as γ(sᵢ). Then the cost of an edit script S is calculated as

$$γ ( {S}_{i} ) = {\sum }_{j = 1}^{k} γ ( {s}_{ij} ) ,$$

the sum of costs of operations in Sᵢ=sᵢ₁, . . . , sᵢₖ.
An optimal edit script between T₁ and T₂ is an edit script between T₁ and T₂ of the minimum cost, and is defined as:

δ(T₁,T₂)=min{γ(Sᵢ)|1≦i≦n}
where n is number of edit scripts that can transform T₁ into T₂. Hence, the tree-edit distance problem is to compute the cheapest edit distance and the corresponding edit script.

The present invention is based on a dynamic-programming approach that splits a tree-edit distance problem to a set of recursive sub-problems shown in pseudo-code in section A below. To accomplish that the algorithm divides a tree into a set of relevant sub-trees that are identified by a set of key roots. Key roots are defined as the set of nodes that includes the root of the tree in addition to all nodes that have at least one left sibling. The key-root set of each tree is then sorted according to the index of the key-root node. Hence, for all combinations of key sub-trees, the algorithm calculates the tree-edit distance starting from smaller sub-trees to bigger ones. The calculations of bigger sub-trees leverage results of smaller ones.

Section A:

DECLARE matrix tdist with size [|T₁|+1] * [|T₂|+1]
DECLARE matrix fdist with size [|T₁|+1] * [|T₂|+1]
FUNCTION treeDistance (x , y)
START

lmx = lm1 (x) // left most node of x
lmy = lm2(y) // left most node of y
bound1 = x − lmx + 2 //size of sub-tree x + 1
bound2 = y − lmy + 2 //size of sub-tree y + 1
fdist[0][0] = 0
// set the first column
FOR i = 1 TO bound1 − 1

fdist[i][0] = fdist[i−1][0] + cost(k,−1)

// set the first row
FOR j = 1 TO bound2 − 1

fdist[0][j] = fdist[0][j−1] + cost(−1,l)

k = lmx
l = lmy
FOR i = 1 TO bound1 − 1

FOR j = 1 TO bound2 − 1

IF lm1(k) = lmx and lm2(l) = lmy
THEN // tree edit distance

fdist[i][j] = min(fdist[i−1][j] + cost(k,−1),

fdist[i][j−1] + cost(−1,l),
fdist[i−1][j−1] + cost(k,l))

tdist[k][l] = fdist[i][j]

ELSE // forest edit distance

m = lm1(k) − lmx
n = lm2(y) − lmy
fdist[j][j] = min( fdist[i−1][j] + cost(k,−1),

fdist[i][j−1] + cost(−1,l),
fdist[m][n] + tdist(k,l))

RETURN tdist[x][y]

END

For greater clarity, the following is presented:

$$Tree \text{-} Edit Distance \\ \begin{matrix}tdist ( x , y ) = tdist ( {T}_{1} [ {lm}_{1} ( x ) … x ] , {T}_{2} [ {lm}_{2} ( y ) … y ] ) \\ = min \{ \begin{matrix}fdist ( {T}_{1} [ {lm}_{1} ( x ) … x - 1 ] , {T}_{2} [ {lm}_{2} ( y ) … y - 1 ] ) + γ ( x , y ) \\ fdist ( {T}_{1} [ {lm}_{1} ( x ) … x - 1 ] , {T}_{2} [ {lm}_{2} ( y ) … y ] ) + γ ( x , λ ) \\ fdist ( {T}_{1} [ {lm}_{1} ( x ) … x ] , {T}_{2} [ {lm}_{2} ( y ) … y - 1 ] ) + γ ( λ , y )\end{matrix}\end{matrix} \qquad Lemma 1$$

where the distance between two forests is defined as:

$$Forest \text{-} Edit Distance \\ fdist ( {T}_{1} [ {x}_{1 } … {x}_{2} ] , {T}_{2} [ {y}_{1 } … {y}_{2} ] ) = min \{ \begin{matrix}\begin{matrix}fdist ( {T}_{1} [ {x}_{1 } … {lm}_{1} ( {x}_{2} ) - 1 ] , \\ {T}_{2} [ {y}_{1 } … {lm}_{2} ( {y}_{2} ) - 1 ] ) + tdist ( {x}_{2} , {y}_{2} )\end{matrix} \\ fdist ( {T}_{1} [ {x}_{1} … {x}_{2} - 1 ] , {T}_{2} [ {y}_{1 } … {y}_{2} ] ) + γ ( {x}_{2} , λ ) \\ fdist ( {T}_{1} [ {x}_{1 } … {x}_{2} ] , {T}_{2} [ {y}_{1 } … {y}_{2} - 1 ] ) + γ ( λ , y )\end{matrix} \qquad Lemma 2$$

As illustrated by FIGS. 2a and 2b, during each tree-edit distance calculation between T₁[x] and T₂[y], one aspect of the invention chooses the minimum cost option of the three following aspects:
The cost of mapping node x to node y plus the cost of matching the remaining forests to each other.
The cost of deleting node x plus the cost of matching remaining forest of first tree against the entire second tree.
The cost of inserting node y plus the cost of matching entire first tree against remaining forest of the second tree.

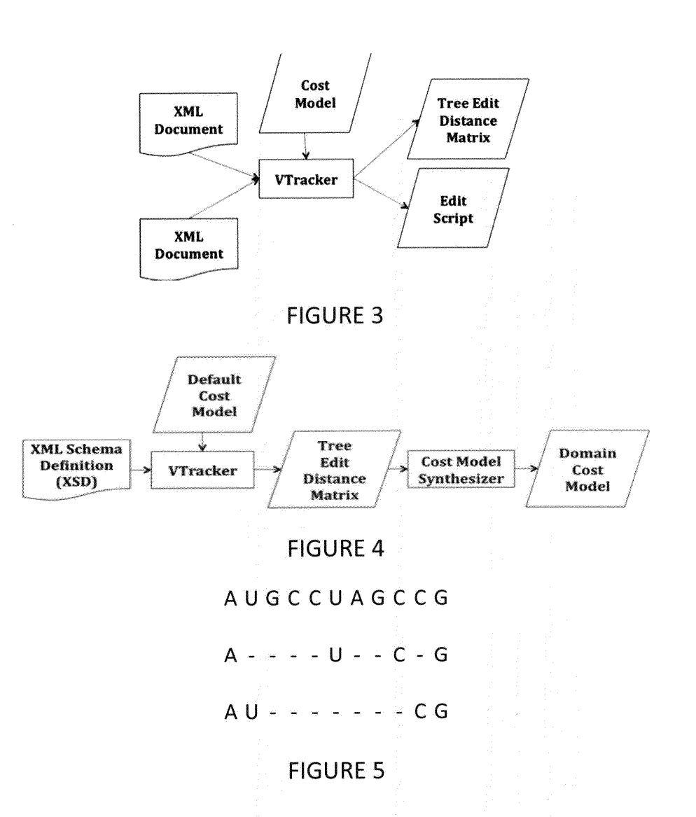

One aspect of the invention provides a tree-edit distance method that calculates the minimum edit distance between two trees given a cost function for different edit operations (e.g. change, deletion, and insertion). This aspect of the invention uses an affine-cost policy in which the cost of each operation may be adjusted based on the context in which it is applied. In a post-processing step, this aspect of the invention applies a simplicity-based filter to discard the more unlikely solutions from the solution set produced by the tree-alignment phase. The resulting method is both reference-aware and context-aware based on back cross-references between nodes of the compared trees. As shown in FIG. 3, given two XML documents and a cost model, the method (named VTracker in the Figure) produces the cheapest edit script that will transform the first document into the second one in conjunction with the edit script associated with the reported distance.

For one aspect of the invention, an XML tree is composed of a set of nodes, where each node is either a text node or an element node. A text node only has a value while an element node has a name, attributes, and/or children nodes. Each node has one parent. An attribute has a name and a value. A value is a literal value, an identifier, or a reference to an identifier. The reference model inside an XML document is either imposed by the underlying XML DTD or XML Schema, or just logically embedded in the application. To be more specific, in DTD, an identifier attribute is declared as a type ID and a reference attribute is declared as an IDREF. Although the XML referencing model is a critical player in the XML business none of the previous XML differencing approaches pays it the appropriate attention. It should be noted that only text and element nodes are considered in this aspect of the invention since all other types of nodes, such as processing instructions and comments, do not add any value to the semantics of the document. Similarly, empty text nodes and text nodes consisting of only white spaces are ignored.

The present invention also uses an innovative cost model. The cost model is the module responsible for assessing the cost of various edit-operations such as deleting a node, inserting a node, or changing a node label. This context-oriented cost model is described below in relation to its different features such as change edit cost, deletion (or insertion) edit costs, and the relative weight between the change and deletion (or insertion) edit costs.

Context-Oriented Change Edit Cost

Given two tree nodes, a simple change edit cost assessment would follow a binary function that yields one of two values: zero in the case of perfect match, a constant value otherwise. However, in practice, two nodes that are not exactly the same may also not be entirely different. For the invention, a matching cost is not a binary function but is an analog function where a matching cost value may range from zero, in the case of a perfect match, to a maximum constant, to indicate an impossible match. A simple implementation of such an analog cost function would measure the string distance between the two node names, their attributes, etc. However, some nodes that do not have similar names may have similar semantics. As well, some nodes that may have literally similar names may have very distinct meanings. Therefore, in order to produce accurate solutions that are intuitive to domain experts, a useful solution needs to be equipped with a domain-specific cost function that correctly captures the understanding of subject-matter experts as to what constitutes similarity and difference among elements in the given domain. But, lacking such knowledge, a standard cost function can always be used as a default, which may, however, sometimes yield less accurate and non-intuitive results.

To address the challenge of formulating a “good” domain-specific cost function, the present invention uses an innovative method for synthesizing a cost function from the domain's XML schema. This is done by relying on the assumption that the XML schema captures in its syntax a substantial part of the domain's semantics. Essentially, the cost model assumes that the designers of the domain schema used their understanding of the domain semantics to identify the basic domain elements and to organize related elements into complex ones.

Once an implementation of the invention has been used first to develop a domain-specific cost function, it can be used to compare XML documents that are instances of the schema based on which the cost function has been developed. FIG. 4 illustrates the bootstrapping process that should happen once, and for good, for each new domain. Given the domain's XSD along with the default cost model, the implementation of the invention is used to compare the schema elements against each other while trying to measure similarities, i.e. edit distance between them as if it is a regular XML document. A distance matrix between defined elements is then produced. The distance matrix is the core of the cost model as it specifies the possibility that two elements are replaceable.

Table 1 below depicts a sample of the cost model that was synthesized based on OWL/RDF XSDs. This sample shows all labels with distance more than 0%, and less than 8%. Each row shows the distance between two node labels followed by a percentage where 0.0% means a perfect match, and 100% means an impossible match. This distance can also be interpreted as a similarity measure between nodes of the two given trees. For instance, two nodes with a 15% distance would be more acceptable as a replacement of each other than those with a 90% distance. As shown in this table, the method of the invention managed to uncover the semantics of the domain that are implicitly embedded in the underlying XSD, and was able to find only relevant matches. Then, the cost function produced is used to compare instances of this given XSD.

TABLE 1

| | | |
|---|---|---|
| cardinality | maxCardinality | 2.78% |
| cardinality | minCardinality | 2.78% |
| Subject | object | 3.70% |
| cardinality | qualifiedCardinality | 3.70% |
| cardinality | maxQualifiedCardinality | 4.63% |
| cardinality | minQualifiedCardinality | 4.63% |
| backwardCompatibleWith | incompatibleWith | 5.56% |
| maxCardinality | minCardinality | 5.56% |
| maxQualifiedCardinality | minQualifiedCardinality | 5.56% |
| maxQualifiedCardinality | qualifiedCardinality | 5.56% |
| minQualifiedCardinality | qualifiedCardinality | 5.56% |
| allValuesFrom | someValuesFrom | 6.48% |
| annotatedProperty | annotatedSource | 6.48% |
| annotatedProperty | annotatedTarget | 6.48% |
| annotatedSource | annotatedTarget | 6.48% |
| maxCardinality | maxQualifiedCardinality | 6.48% |
| maxCardinality | minQualifiedCardinality | 6.48% |
| maxCardinality | qualifiedCardinality | 6.48% |
| minCardinality | maxQualifiedCardinality | 6.48% |
| minCardinality | minQualifiedCardinality | 6.48% |
| minCardinality | qualifiedCardinality | 6.48% |
| sourceIndividual | targetIndividual | 6.48% |
| AsymmetricProperty | SymmetricProperty | 6.67% |
| IrreflexiveProperty | ReflexiveProperty | 6.67% |
| intersectionOf | unionOf | 7.41% |
| oneOf | unionOf | 7.41% |
| unionOf | oneOf | 7.41% |
| ReflexiveProperty | TransitiveProperty | 7.78% |

It should be noted that the quality of the cost-model synthesizer largely depends on the richness and restriction of the given XSD. The richer and more restrictive the XSD the better the quality of the cost-model achieved. If the given XSD does not capture the majority of the domain semantics, then the synthesizer may produce unusable results. It should also be noted that it is always possible to manually configure the domain cost model, or even to fix the synthesized one. It should further be mentioned that the bootstrapping process can help in building a cost function to translate between two different schemas. In this case, the implementation of the invention has to be provided by the two XSDs.

Context-Oriented Deletion/Insertion Edit Cost

A simple cost function assigns a uniform cost value to all deletion and insertion operations regardless of the context where the operation is applied. Thus, the cost of a node insertion/deletion is always the same, regardless of whether or not that node's children are also to be deleted (or inserted). However, a parent node becomes less important if all its children are deleted. In order to produce more intuitive tree-edit sequences, the method of the present invention uses an affine-cost policy.

The idea of a affine-cost function is fairly simple. Intuitively, the concept is that a single long insertion should be cheaper than several short ones of the same total lengths. For example, FIG. 5 shows two possibilities of matching two strings “AUGCCUAGCCG” and “AUCG” (where dashes represent insertions and deletions). The first possibility has more gap fragments than the second. According to the affine-gap policy, the hypothesis is that “it is always cheaper by dozen.”, and that deletions and insertions tends to happen at contingent elements rather than dispersed ones.

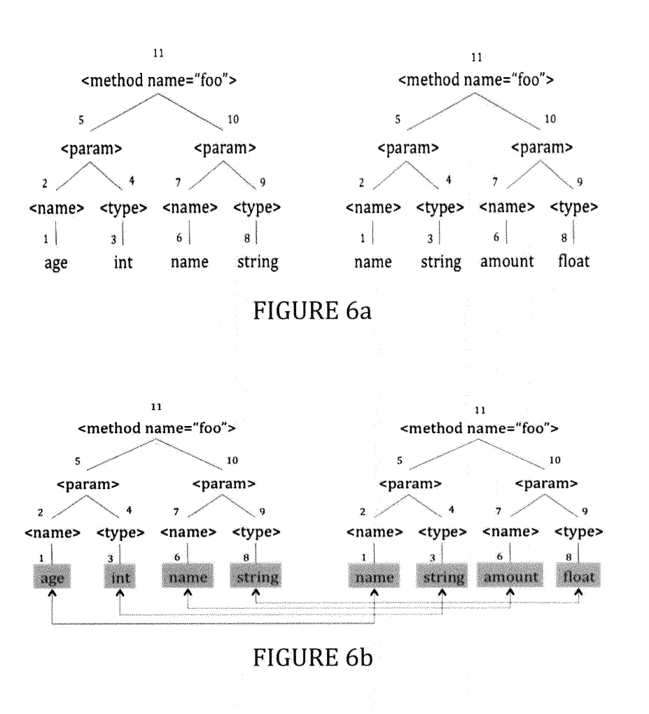

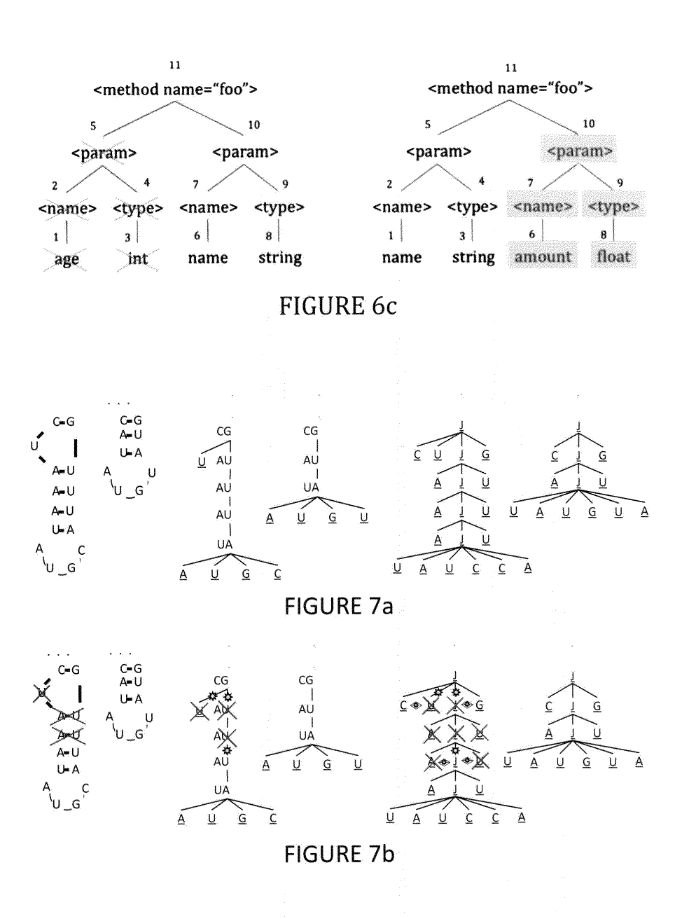

In this aspect of the invention, a node's deletion (or insertion) cost is context sensitive. If all of a node's children are also candidates for deletion, this node is more likely to be deleted as well and, thus, the deletion cost of that node should be less than the regular deletion cost. The same is true for the insertion cost. If all of a node's children are also candidates for insertion, this node is more likely to be inserted as well and, thus, the insertion cost of that node should be less than the regular insertion cost. To reflect this heuristic, the cost of the deletion or insertion of such a node is discounted by a certain percentage. FIGS. 6a-6c are used to illustrate the importance of an affine-cost function. For this example, a standard cost function can be assumed where the cost of a deletion or an insertion is 3 while the cost of change is 6. The example will consider the two trees of FIG. 6(a). According to the cost function, the cost of the differencing shown in FIG. 6(b) is 24 (four change operations) while the cost of the differencing of FIG. 6(c) is 30 (five deletion operations+five insertion operations). Therefore, according to this cost function, solution FIG. 6(b) is the optimal solution since it is cheaper (i.e. has a lower cost). With a closer look at why FIG. 6(c) is so expensive, structure nodes like <param>, <name> and <type> are found to be more costly to delete, as they are numerous. However, such structure nodes have no value if their contents are to be deleted. The advantage of an affine-cost function comes into play as such a function discounts the edits to these structure-preserving nodes in case all their children are to be deleted. For example, according to a 66.6% discount policy, deleting or inserting any of the structure nodes will cost one unit instead of three units each. In other words, if one were to apply an affine-cost policy on the solution in FIG. 6(c), the cost will be 18 units (two regular deletions of three units each+three discounted deletions of one unit each+two regular insertions of three units each+three discounted insertions of one unit each). This cost will promote the solution shown in FIG. 6(c) to be more optimal than the solution shown in FIG. 6(b).

From the above, it should be clear that the question then becomes one of how to decide if a node is eligible for an affine discount. In other words, while calculating the edit cost between two nodes x and y, the method has to determine whether the children of x, y, or both are to be deleted. As shown in the pseudo-code of Section B, for the cost function to decide whether this node is eligible for an affine policy discount, it has to leverage the distance calculations of this node's sub-forest. It checks if the cost of deleting the forest fdist[0 . . . x−1, 0 . . . y−1] equals the summation of fdist[0 . . . lm₁(x)−1, 0 . . . y−1] plus the deletion cost of T₁[lm₁(x)−1 . . . x−1]. A cell is eligible for a deletion affine discount, if and only if, either the cell is in the first column since the first column always means a full deletion, or the accumulated cost recorded with this node's children equals the cost of deleting the same children. The eligibility of the insertion affine discount is similarly calculated.

Section B:

FUNCTION IsDeleteAffineEligible (x, y)
START

IF y = 0
THEN // the whole tree is to be deleted

RETURN true

ELSE

// Cost of matching the remaining forests to each other
CostRemaingForest = fdist [lm1 (x)−1][y]
// Cost of matching sub-forest is the actual cost minus
// Cost of matching the remaining forests to each of the
CostSubForest = fdist [x−1][y] − CostRemaingForest

// Cost of deleting everything minus
// Cost of matching the remaining forests to each other
CostDelSubForest = fdist [x−1][0] − fdist [lm1 (x)−1][0]

IF costSubForest = CostDelSubForest

RETURN true

ELSE

RETURN false

END

Relative Weight Between Deletion and Change Edit Costs

While the above discusses the importance of context-sensitive cost functions on the dimensions of change, and deletion/insertion edit operations, the question remains of what is the proper relative weight between these three types of operations? In practice, the cost value itself is not that important. Of greater importance is the relative cost between the different operations. In actuality, the cost of a deletion operation should always equal the cost of an insertion operation. Then the question becomes: what is the relation between the cost value of deletion/insertion and the cost value of change? Many related works use a uniform cost model where deletion, insertion, and change operations have the same unit cost. However, the uniform cost model gives the change operation more privilege than the deletion and insertion operations. For example, if two nodes are totally different, under the uniform cost model, it will cost more to delete and insert compared to simply changing or matching the nodes. Matching the nodes to each other will cost one unit while the cost of deleting the first node plus inserting the second node will cost two units. Because of this, the match (or change) option will always be favored over deletion and insertion operations since matching will cost less. To address this issue, in the cost model used for the present invention, the cost of change should be at least equal to the sum of the deletion and insertion costs. This would give a fair chance between all the three operations. In that way, if two nodes are:
Perfect match, then their matching cost will be zero.
Partially similar, then their matching cost will be prorated to the maximum matching cost, which should be less than the cost of deleting the first node plus the cost of inserting the second node.
Entirely different, then the cost of matching the nodes will equal the cost of deleting the first node plus the cost of inserting the second node, which gives both choices a fair chance to be favored by further calculations at subsequent nodes.

Basic Cost Functions

One implementation of the invention uses a set of cost functions to measure the basic distance between different elements. One of the most common cost functions is the Levenshtein string-edit distance, and is used (a) to measure the distance between couples of string tokens, which is always normalized to the size of the two tokens; and (b) to measure the distance between two sets of tokens. In this case, Levenshtein's string-edit distance is used at two levels: once on the character level inside each token, and once more on the token-level for each set. Also, Levenshtein's string-edit distance is used to measure the distance between attribute names, and between attribute values.

Considering Outgoing References

Another advantage of present method over other differencing methods is the integration of the XML referencing structure into the XML containment structure. This enables the present method to compare more complex structures (i.e. trees with back references) than others which only compare proper trees. It should be noted that the approach presented in this document only considers references to nodes within the same document. References to external elements are currently ignored. However, a workaround would include all external documents along with the main document into one tree structure.

A typical interpretation of such references is that the referenced element structure is meant to be entirely copied under the reference location. However, to avoid duplications and inconsistencies, elements are reused through a reference to a common definition. One option is to handle such referencing cases by just copying the content of the common element specification to every reference occurrence. This approach leads to large tree structures, especially in cases with many such cross-references. In addition to increasing the size of the tree and thereby increasing the time necessary for the computation, such “duplication” of elements to all their reference locations decouples them from each other. This decoupling allows them to be treated as independent entities with just an “accidental” similarity in their internal structure and naming, thereby fundamentally misrepresenting the intent of the schema designer.

The question then becomes how to adjust the cost function in order to compute the differences of two nodes in terms of the similarities and differences of the elements they contain and refer to. The answer to this question is straightforward: a referenced structure should be considered as an extension to the containment structure. As explained in Lemma 3 below, in order to assess the matching edit cost between two nodes x and y, the following cases have to be considered:
Neither node has a hyperlink attribute: a regular matching cost assessment is applied either through a domain-specific cost function or by applying a string-edit distance between the element names, attributes, and values.
One node has a hyperlink attribute: a tree-edit distance measure is calculated between the referenced structure on the hyperlink side against the entire sub-tree on the other side.
Both nodes have hyperlink attributes: a tree-edit distance measure is calculated between both referenced structures.

Lemma 3: Reference-Aware Cost Function

In order to consider the reference-structure as a supplemental part of the tree-edit distance calculation, the cost function γ is modified to be:

$${γ}^{′} ( x , y , p ) = \{ \begin{matrix}\frac{tdist ( {x}^{′} , y , p )}{tdist ( {x}^{′} , λ ) + γ ( λ , y )} {γ}_{max} & x -> {x}^{′} \\ \frac{tdist ( x , {y}^{′} , p )}{γ ( x , λ ) + tdist ( λ , {y}^{′} )} {γ}_{max} & y -> {y}^{′} \\ \frac{tdist ( {x}^{′} , {y}^{′} , p )}{tdist ( {x}^{′} , λ ) + tdist ( λ , {y}^{′} )} {γ}_{max } & x -> {x}^{′} \& y -> {y}^{′} \\ γ ( x , y ) & otherwise\end{matrix}$$

Modifying a cost function to be reference-aware is conceptually a simple task. However, there are a few issues that have to be considered during the implementation. Three challenges need to be considered during the implementation of a reference-aware cost function.

Normalized Values

The expected output of the cost-assessment function is a value between zero and the maximum matching cost. However, following a hyperlink and involving a reference structure in the calculation may yield a distance value that is relative to the size of the referenced structures. Therefore, a normalization step is required to make sure that the reported matching distance is within range. As shown in Lemma 3, this can be accomplished by dividing the calculated tree-edit distance of the referenced structures by the cost of deleting them. This will yield a value less than, or equal to, 1.0. Finally, this value is multiplied by the maximum matching cost so that it is leveled with the normal matching cost.

Infinite Loops

A challenge that arises when XML elements hold references to other elements is in how to prevent the method from falling into an infinite loop as it follows these references. To prevent this, the cost function should be equipped with a simple stack trace p that maintains the recursion path of the current calculations. Accordingly, the cost function γ′(x, y, p) accepts a recursion stack parameter p to ensure that the same state is not visited twice.

Performance

Another matter which must be noted is the performance of reference-aware edit distance calculation. The performance of the base method largely relies on the order in which sub-trees are compared to each other. The algorithm has a very specific order by which it calculates sub-problems so that rework is avoided or at least minimized. The base algorithm uses the concept of key-trees, on top of the dynamic programming model, to decide the order in which sub-problems should be solved so that no recursion is required, in part, because recursive calculations dramatically affect the amount of memory space required to solve the problem. However, in addition to the containment hierarchy, the present method also follows the reference relations between elements which affect the actual dependencies between sub-trees and consequently impacts the “proper” order in which sub-tree mappings should be calculated. References can unexpectedly occur from any node to any other node and this can dramatically change the order in which sub-trees are compared. This can dynamically increase the degree of recursion required to solve the problem.

To mitigate the above issue, the present method sorts key sub-trees based on their references, following the following two sorting criteria:
a) Popularity of the node: the number of inbound references. Sub-trees with more inbound references should be considered before others with a fewer number of inbound references. This criterion guarantees that high-demand nodes are always calculated before low-demand ones so that calculations of high-demand sub-trees are always ready first which in turn dramatically decreases the number of possible recursions
b) Pre-requisites of a node: the number of outbound references. Nodes with many out-bound references (i.e. hyperlinks) are harder to calculate especially if their referenced sub-trees have not been calculated at that time. Therefore, sub-trees with many pre-requisites should be delayed to the end so that most of their referenced sub-trees are calculated first.

Considering Usage-Context (Incoming References)

In usage-context matching, the present method considers not only the internal and referenced structure of an element but also the context in which this element is used, namely the elements from which this element is being referenced. As discussed earlier, usage-context distance is used to resolve confusions that may happen in the regular tree-edit distance calculation.

In a post-calculation process, usage-context distance measures are calculated and combined with standard tree-edit distance measures into a new context-aware tree-edit distance measure. For each two nodes x and y, two context-usage sets are established from nodes that having references to node x and node y, respectively. Then, the usage-context distance between the two sets is calculated as the Levenshtein distance between elements of the sets, where the distance between any two elements is the tree-edit distance between them, and the total Levenshtein distance is then called the usage-context distance between x and y. Finally, the context-aware tree-edit distance measure is the average between the usage-context distance and the tree-edit distance measure.

Selecting the Optimal Edit Script

Other methods formulated for the differencing problem only describe the process of calculating a tree-edit distance and do not describe the proper way of recovering the edit script associated with this distance. Under the conditions of a perfect cost function there should be only one optimal edit script that transforms one tree into the other. In practice, such a perfect cost function is unlikely (even impossible) to exist, leading to the fact that a tree-edit distance may have multiple corresponding edit scripts, all with the same cheapest total cost value. It is therefore useful to mention that these various edit scripts may be quite different and they may report very different solutions.

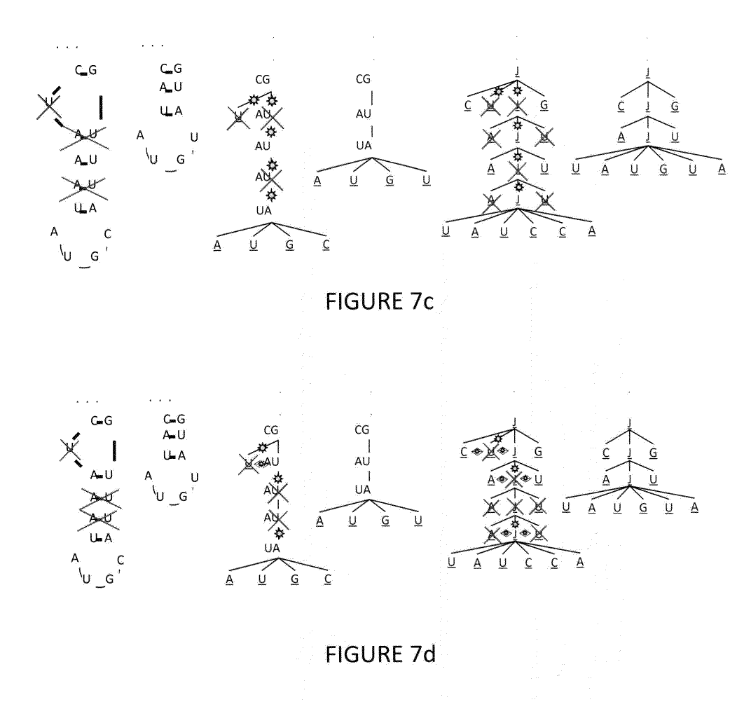

To explain the above, FIGS. 7a-7d are provided. FIG. 7(a) shows segments from two RNA secondary structures represented in two kinds of tree structures. This example is interesting because in both tree representations, there are three possible edit scripts, i.e. solutions all with the same cost shown in FIGS. 7(b)-(d). Each of these edit scripts corresponds to a different sequence of evolutionary operations that may have led to the production of one tree rather than another. The question is therefore that of which solution should be reported as the differencing result. The present invention uses an innovative set of simplicity heuristics which are designed to discard the unlikely solutions from the possible set. During this phase, three different simplicity criteria are applied to decrease a set's cardinality by eliminating solutions that do not meet the criteria. It should be noted that the leftmost 2 diagrams are RNA segments, the middle two diagrams are TFG representations of the same segments, and the rightmost two diagrams are LFG representations of the same two diagrams for all of FIGS. 7(a)-7(d).

Path Minimality

Intuitively, the first simplicity criterion eliminates “non minimal paths”—when there is more than one different path with the same minimum cost, the one with the least number of deletion and/or insertion operations is preferable. This criterion aligns very well with the requirement of having a minimal delta, i.e., a minimal edit script. In the example of FIGS. 7(a)-7(d), since all solutions have the same number of edit-operations, no solution is discarded in this phase of filtration.

Vertical Simplicity

The second simplicity heuristic eliminates any edit sequences in which “non-contiguous similar edit operations” exist. Intuitively, this rule assumes that a contiguous sequence of edit operations of the same type essentially represents a single mutation or refactoring on a segment of neighboring nodes. Thus, when there are multiple different edit-operation scripts with the same minimum cost, and the same number of operations, the one with the least number of changes (refractions) of operational types along a tree branch is preferable.

This heuristic is implemented by counting the number of vertical refraction points. A vertical refraction point is defined as a node where the editing operation applied to its parent differs from the operation applied to this node. For example, solution two (FIG. 7(c)) has five vertical refraction points; contrast this with either solution one (FIG. 7(b)) or solution three (FIG. 7(d)) that each have only three vertical refraction points. Solutions one and three are therefore simpler than solution two as they have fewer vertical refraction points. Solution two is thus discarded while solutions one and three pass this filtration step.

Horizontal Simplicity

This filtering criterion is implemented by counting the number of horizontal refraction points. A horizontal refraction point is defined as a node where the operation applied to its sibling differs from the operation applied to this node. For example, in the case of the Tight Fine-Grained (TFG) tree representation solution one (FIG. 7(b)) has no horizontal refraction points and solution three (FIG. 7(d)) has one refraction points; in the case of the Loose Fine-Grained (LFG) tree representation solution one has four horizontal refraction points and solution three has six. Therefore, solution one is identified as the simplest edit script by having the most contiguous similar edit operations.

Domain-Aware Optimizations

The present invention, when provided with a domain-specific cost function that defines the similarity measure between various kinds of elements, optimizes performance by deciding on the feasibility of a sub-tree-to-sub-tree correction process before carrying it out. In other words, the method should not start matching two sub-trees if the roots of the two sub-trees are not of replaceable types. In this way, an unfeasible sub-tree will be skipped while focusing only on the feasible ones.

Formally speaking, the similarity measure ρ is always true by default unless specified otherwise by the following formula:

$$ρ ( x , y ) = \{ \begin{matrix}false & γ ( {l}_{1} ( x ) , {l}_{2} ( y ) ) > threshold \\ true & otherwise\end{matrix}$$

where node-label distances are provided by the domain-specific cost function. In this way, the tree-edit distance between two sub-trees is skipped if the two root nodes are not replaceable which leads to an optimized version of the forest distance calculations explained in Lemma 4 below.

$$Forest \text{-} edit distance with similarity measure \\ fdist ( {T}_{1} [ {x}_{1 } … {x}_{2} ] , {T}_{2} [ {y}_{1 } … {y}_{2} ] ) = min \{ \begin{matrix}\{ \begin{matrix}\begin{matrix}fdist ( {T}_{1} [ {x}_{1 } … {lm}_{1} ( {x}_{2} ) - 1 ] , \\ {T}_{2} [ {y}_{1 } … {lm}_{2} ( {y}_{2} ) - 1 ] ) + tdist ( {x}_{2} , {y}_{2} )\end{matrix} & ρ ( {x}_{2} , {y}_{2} ) \\ ∞ & otherwise\end{matrix} \\ \begin{matrix}fdist ( {T}_{1} [ {x}_{1 } … {x}_{2} - 1 ] , {T}_{2} [ {y}_{1 } … {y}_{2} ] ) + γ ( {x}_{2} , λ ) \\ fdist ( {T}_{1} [ {x}_{1 } … {x}_{2} ] , {T}_{2} [ {y}_{1 } … {y}_{2} - 1 ] ) + γ ( {x}_{2} , λ )\end{matrix}\end{matrix} \qquad Lemma 4$$

Lemma 4 may be proven as follows:

When nodes x₂ and y₂ are not replaceable, the first option in the tdist (see Lemma above) formula becomes very expensive, and will be discarded, which will only leave two options:

$$\begin{matrix}tdist ( {x}_{2} , {y}_{2} ) = tdist ( {T}_{1} [ {lm}_{1} ( {x}_{2} ) … {x}_{2} ] , {T}_{2} [ {lm}_{2} ( {y}_{2} ) … {y}_{2} ] ) \\ = min \{ \begin{matrix}\begin{matrix}fdist ( {T}_{1} [ {lm}_{1} ( {x}_{2} ) … {x}_{2} - 1 ] , \\ {T}_{2} [ {lm}_{2} ( {y}_{2} ) … {y}_{2} ] ) + γ ( {x}_{2} , λ )\end{matrix} \\ \begin{matrix}fdist ( {T}_{1} [ {lm}_{1} ( {x}_{2} ) … {x}_{2} ] , \\ {T}_{2} [ {lm}_{2} ( {y}_{2} ) … {y}_{2} - 1 ] ) + γ ( λ , {y}_{2} )\end{matrix}\end{matrix}\end{matrix}$$

Substituting these two options with Lemms 2 above results in the following forest distance formula representing the case when x₂ and y₂ which are not replaceable.

$$fdist ( {T}_{1} [ {x}_{1 } … {x}_{2} ] , {T}_{2} [ {y}_{1 } … {y}_{2} ] ) = min \{ \begin{matrix}\begin{matrix}fdist ( {T}_{1} [ {x}_{1 } … {lm}_{1} ( {x}_{2} ) - 1 ] , {T}_{2} [ {y}_{1 } … {lm}_{2} ( {y}_{2} ) - 1 ] ) + \\ fdist ( {T}_{1} [ {lm}_{1} ( {x}_{2} ) … {x}_{2} - 1 ] , {T}_{2} [ {lm}_{2} ( {y}_{2} ) … {y}_{2} ] ) + γ ( {x}_{2} , λ )\end{matrix} \\ \begin{matrix}fdist ( {T}_{1} [ {x}_{1 } … {lm}_{1} ( {x}_{2} ) - 1 ] , {T}_{2} [ {y}_{1 } … {lm}_{2} ( {y}_{2} ) - 1 ] ) + \\ fdist ( {T}_{1} [ {lm}_{1} ( {x}_{2} ) … {x}_{2} ] , {T}_{2} [ {lm}_{2} ( {y}_{2} ) … {y}_{2} - 1 ] ) + γ ( λ , {y}_{2} )\end{matrix} \\ fdist ( {T}_{1} [ {x}_{1 } … {x}_{2} - 1 ] , {T}_{2} [ {y}_{1 } … {y}_{2} ] ) + γ ( {x}_{2} , λ ) \\ fdist ( {T}_{1} [ {x}_{1 } … {x}_{2} ] , {T}_{2} [ {y}_{1 } … {y}_{2} - 1 ] ) + γ ( λ , {y}_{2} )\end{matrix}$$

In order to prove Lemma 4, it is necessary to prove that the first two options in the above formula are not necessary since they are considered in the other two options. In other words, it is necessary to prove that

fdist(T₁[x₁ . . . lm₁(x₂)−1],T₂[y₁ . . . lm₂(y₂)−1])+fdist(T₁[lm₁(x₂) . . . x₂−1],T₂[lm (y₂) . . . y₂])≧fdist(T₁[x₁ . . . x₂−1],T₂[y₁ . . . y₂])

Finally, Lemma 4 will enhance the performance of a generic differencing method by skipping unnecessary sub-tree matching. In this way, there is a decrease in the complexity of being O(n⁴) in worst case and O(n³) in average case, to be O(n²) in average case and to thereby reduce the possibility of the worst case even if its complexity remains the same.

From the above, the present invention therefore has the following advantages:

Not domain specific: by definition the present method is designed to handle any kind of XML differencing problem. It is also capable of becoming domain-aware, using a domain-specific cost function, and constructed in the bootstrapping process, in order to produce results that are sound and reasonable in terms of the domain knowledge and semantics.

Meaningful minimal edit script: The method accomplishes this objective in many ways such as by using the affine-cost policy and the simplicity heuristics, both of which are described above.

Hierarchal data structure: the present invention views an XML document as an ordered labeled tree. Also, mapped elements should obey both the ancestor-child and siblings.

Changes anywhere: The present invention does not favor certain kinds of changes over other kinds. It is capable of detecting changes happening to internal structure nodes as efficiently as changes happening to leaf nodes. As well, it does not favor certain patterns of changes or edit operations.

Object Identity: for the present invention, an element is identified by its name, attributes, value, and structure The present invention also uses ancestor and siblings relationships to identify an element. Although it does assume or require that given XML documents have some kind of atomic IDs, it utilizes key attributes if specified by the domain configuration. Moreover, it uses both the reference and usage-context structure to reinforce the identity of a certain element.

No prior change tracking: by definition the present method does not require edits to be done through a certain tool, utility, or IDE. It is also capable of comparing documents originated from different sources, or by different vendors.

Efficiency: The present invention provides an optimization technique that is based on a domain-specific cost function; it focuses on comparing trees that are replaceable as described above

Reference structure: The present invention views the XML reference structure as a part of referring structures as described above.

Usage-Context Structure: The method described above uses usage-context similarity as an extra measure to validate and reinforce the calculated tree-edit distance results.

The above described method may also be used to match ontologies. The World Wide Web Consortium (W3C) defines ontology as a set of “formalized vocabularies of terms, often covering a specific domain and shared by a community of users”. Ontologies are important to formally describe a certain domain's terminologies, vocabularies, concepts, and relationships. An ontology description usually defines elements such as individuals (i.e. objects), classes, attributes, relationships, or restrictions on relationships. One important ontology-description language is Web Ontology Language (OWL) that is designed to serve the needs of Semantic Web and Service Oriented Architecture.

Ontology matching is a task necessary for a variety of activities such as migration and bridging between various versions and evolutions of the same ontology, translation between different ontologies, discovery and composition of services, integration of software systems, and linking web-accessible data. In nearly every scenario where software components of different parties need to interact, it is necessary to translate between their underlying ontologies. The term “ontology matching” refers to the problem of identifying the proper semantic mapping between entities of different ontologies representing the same conceptual domains. The general technical problem driving the research around ontology matching is part of the overall Semantic-Web agenda, which envisions that the information available on the web will be annotated with semantic metadata in the form of ontology tags, and that heterogeneous information, provided by people and organizations will be integrated through mapping of their tag ontologies. As centralized coordination of the ontology-development process is unlikely, one can anticipate an explosion in the number of ontologies used today. Many of these ontologies describe similar (the same or overlapping) domains, but use different terminologies. To integrate data from such disparate ontologies one must recognize the semantic correspondences between their elements. Manual mapping of such correspondence is time-consuming, error prone, and clearly not possible on the web scale. This is why general, applicable across domains, automated methods for ontology mapping are necessary.

Ontology matching is the process of finding a semantic mapping between elements of two different ontologies. OWL/RDF is used in the discussion below as an example of ontology specification language. According to W3C 2009 specification the primary exchange format for OWL2 is RDF/XML. Section C shows a portion of an OWL Ontology described in RDF/XML syntax. This example is a part of the reference ontology specification used in the OAEI benchmark dataset. As shown in this example, the OWL ontology is composed of a set of classes, object properties, and individual objects. Each of those elements is then defined either in its own terms, or by referring to definitions of other elements.

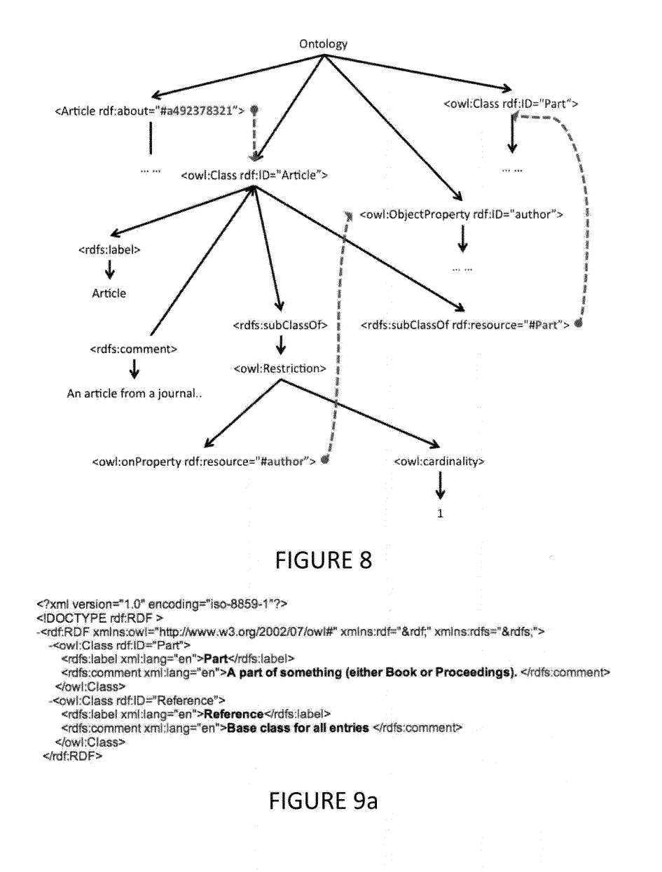

As an XML document an OWL ontology specification can be represented as a tree. The present invention is based on a DOM model as a tree representation of an XML document where all XML elements such as classes, properties, relationships and restrictions are represented as tree nodes, and where element names are represented as tree labels and XML attributes are represented as node attributes. Metadata elements such as XML instructions and comments are not included in the tree model. For example, FIG. 8 illustrates this idea by visualizing the ontology described in the code in Section C as a tree. In this tree the ontology defines two classes named Article and Part, one object property named author, and one individual with id a492378321. Similarly, the Article class definition is composed of a label, a comment, and two inheritance relationships: the first is a restricted version of the author object property while the second is a normal sub-class relationship of Part class definition. In conjunction with the XML containment structure, this example illustrates another type of structure that is called the reference structure. In FIG. 8 the solid lines denote containment relationships while the dotted arrows denote reference relationships. In this tree there are three reference relationships: an instantiation relationship between article #a492378321 and the class definition of Article, and two association relationships linked to the definitions of the Part class and the author object property. The intent of such a reference structure is to allow ontological definitions to be reused within other definitions. This kind of hyperlinkage dramatically affects the semantics of an element's definition. Although the referenced element definition is not physically a part of the referring structure, it is definitely a part of its semantics. Therefore, when definitions of two elements are matched to each other it is not enough to only match the containment structure on both sides but also the referenced structures as well. In other words, a differencing approach should consider referenced structures as being a part of the referring structure.

Section C:

<rdf:RDF>

<owl:Class rdf:ID=“Article”>

<rdfs:label xml:lang=“en”>Article</rdfs:label>
<rdfs:comment xml:lang=“en”>An article from a journal or

magazine.</rdfs:comment>

<rdfs:subClassOf>

<owl:Restriction>

<owl:onProperty rdf:resource=“#author”/>
<owl:cardinality

rdf:datatype=“&xsd;nonNegativeInteger”>1

<owl:cardinality>

</owl:Restriction>

<rdfs:subClassOf>
<rdfs:subClassOf rdf:resource=“#Part”/>
</owl:Class>

<owl:ObjectProperty rdf:ID=“author”>

<rdfs:subPropertyOf rdf:resource=“#humanCreator”/>
<rdfs:label xml:lang=“en”>author</rdfs:label>
<rdfs:comment xml:lang=“en”>The list of the author(s) of

a

work.</rdfs:comment>

</owl:ObjectProperty>
<owl:Class rdf:ID=“Part”>

<rdfs:subClassOf rdf:resource=“#Reference”/>
<rdfs:label xml:lang=“en”>Part</rdfs:label>
<rdfs:comment xml:lang=“en”>A part of something (either

Book

or Proceedings).</rdfs:comment>

<rdfs:subClassOf>

<owl:Restriction>

<owl:onProperty rdf:resource=“#pages”/>
<owl:maxCardinality

rdf:datatype=“&xsd;nonNegativeInteger”>1

</owl:maxCardinality>

</owl:Restriction>

</rdfs:subClassOf>
<rdfs:subClassOf>

<owl:Restriction>

<owl:onProperty rdf:resource=“#title”/>
<owl:cardinality

rdf:datatype=“&xsd;nonNegativeInteger”>1

</owl:cardinality>

</owl:Restriction>

</rdfs:subClassOf>
<owl:Restriction>

<owl:onProperty rdf:resource=“#isPartOf”/>
<owl:cardinality

rdf:datatype=“&xsd;nonNegativeInteger”>1

</owl:cardinality>

</owl:Restriction>

</owl:Class>

</rdf:RDF>

Returning to the implementation of the present invention to match ontologies, the above shows how an OWL/RDF in XML syntax can be represented as an ordered labeled tree. The present method can thus be applied to match ontologies represented as trees.

Affine-Cost Policy

As discussed above, an affine-cost policy is important to prevent structural formality from having a negative influence on the quality of results. The objective of an affine-cost function is to assign a reduced cost when deleting or inserting internal nodes where all these children are deleted (or inserted) as well. The idea is based on the hypothesis that the purpose of an internal node is to group the structure of its content. Therefore, if its children are deleted, then this internal node loses its purpose and consequently needs to be deleted as well. The affine-cost function reduces its deletion cost to indicate to the method of the invention the diminished importance of such a node.

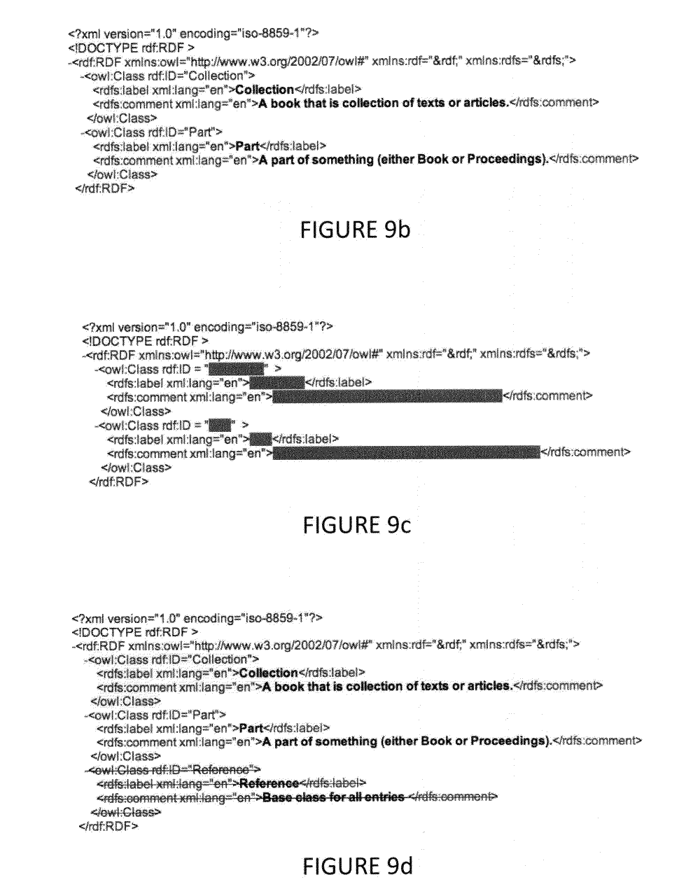

FIGS. 9a-9d are used to illustrate the necessity of an affine-cost policy when matching ontologies. This example matches two ontologies with two class definitions each, shown in FIGS. 9(a) and 9(b). In an OWL ontology definition, the number of structure nodes exceeds that of the text nodes—this means that structure nodes have the upper hand on the matching decision. However, in this example, structure nodes can negatively influence such a decision. It is illustrative to compare the tree-edit distance of the two solutions of FIGS. 9(c) and 9(d) when following a fixed deletion insertion cost versus an affine-cost function. The first solution (see FIG. 9(c)) is where a part class matches a collection class while the reference class is mapped to the part class, which is a rather counterintuitive solution. The second solution (see FIG. 9(d)) keeps the part class unchanged, deletes the reference class, and inserts the collection class.

The following calculations are based on the standard cost function where a deletion costs three units, an insertion costs three units, and a change costs six units. As shown in the table below, following a fixed costing policy, the number of internal nodes affects the total cost of the solution making it a very expensive choice. However, when following an affine-cost policy, the six internal nodes will receive a cost discount since their children are deleted as well. It should now be evident how an affine-cost policy would help to promote solutions that have a significant number of structure changes.

| | Fixed cost | Affine cost |
|---|---|---|
| Solutions | policy | policy |
| Solution 1: | | |
| 4 change Operations | 4 * 6 = 24 | 4 * 6 = 24 |
| 2 attribute changes | 2 * 2 = 4 | 2 * 2 = 4 |
| | Total = 28 units | Total = 28 units |
| Solution 2: | | |
| 4 leaf node | 4 * 3 = 12 | 4 * 3 = 12 |
| deletions | | |
| 6 internal node | 6 * 3 = 18 | 6 * 1.5 = 9 |
| deletions | | |
| | Total = 30 units | Total = 21 units |

Ontology Reference Structure

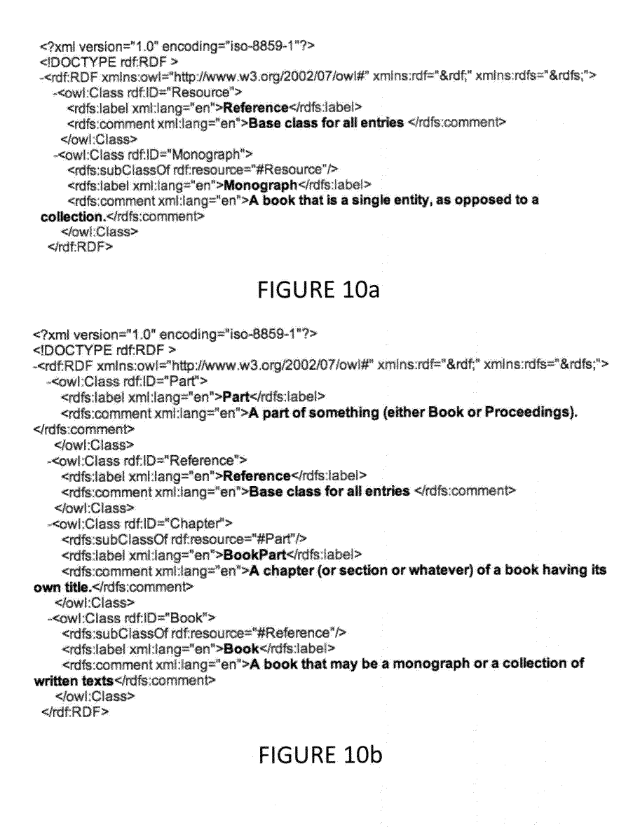

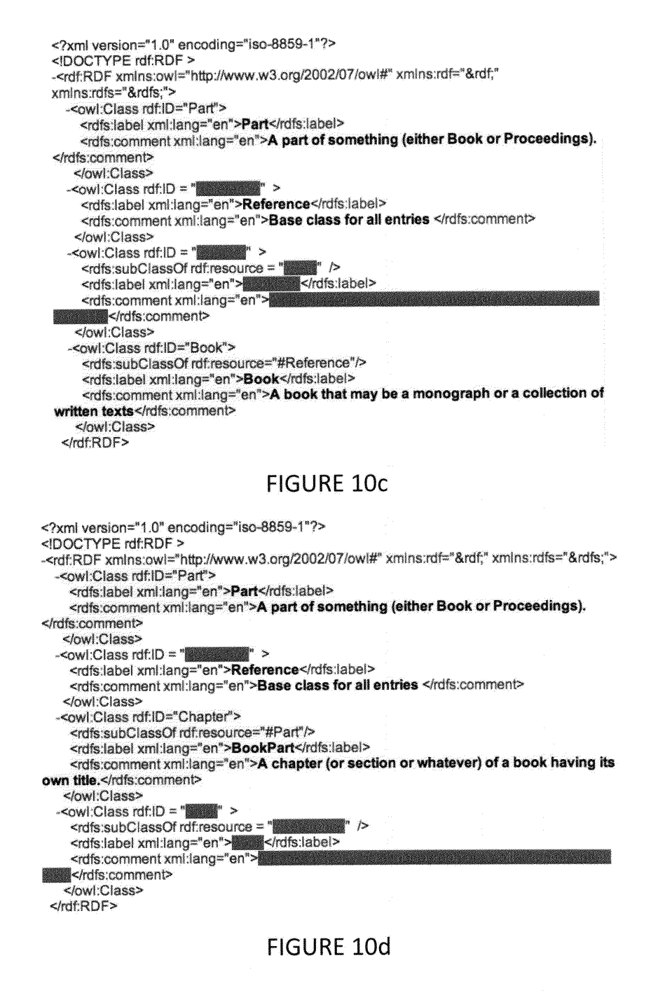

The importance of reference structure when matching ontologies is illustrated using FIGS. 10(a)-10(d). The Figures of the example shows two ontologies. The first ontology, shown in FIG. 10(a), defines two classes, a Resource and a Monograph where a Monograph is a sub class of a Resource. The second ontology, in FIG. 10(b), defines four classes, Part, Reference, Chapter, and Book where Chapter and Book are sub classes of Part and Reference, respectively. Intuitively, the Resource and Reference classes are very similar in terms of their labels and comments, and should be matched to each other. Now, one of the two classes of the first ontology is successfully matched.

The next question is of which class in the second ontology should be mapped to the Monograph class in the first ontology. Comparing the Monograph class definition against the remaining three classes Part, Chapter, and Book, Monograph has keywords that are similar to the three classes. Therefore, due to such confusion, a solution could randomly map Monograph to any of the three classes. FIG. 10(c) shows one such random solution. However, since the present invention is reference-aware, it easily resolves this confusion based on the sub-class relation between the Monograph and Resource classes that are mapped to the Reference class. Put another way, the Monograph should be mapped to a sub-class of the Reference class. As FIG. 10(d) shows, the best solution occurs where Monograph is matched to Book since both are sub-classes of matched classes.

The present invention may be implemented as a generic XML differencing solution and such an implementation is outlined below. The implementation uses Java 2 Standard Edition (J2SE), and is therefore portable to different operating systems and platforms, and it is also capable of running as a standalone or a web application.

A typical deployment of the method is composed of a mandatory component Core in addition to one or more domain-specific modules. Core is main component of an implementation of the present invention and it implements the contributions described above. Core is composed of the following modules:

TreeEditingSuggestor: given two XML documents and a cost function, this module produces a tree-edit distance matrix, and, optionally, edit scripts associated with the calculated distances. This module is responsible for implementing the tree-edit distance algorithm. The implementation of the invention may include different implementations of the tree-edit distance algorithm such as the basic method, the basic method with affine-cost computation, and the method that can be configured with domain-specific parameters for efficiency improvement.

CostAssessor: the cost function is provided to TreeEditingSuggestor in the form of an instance that implements the abstract module CostAssessor. This CostAssessor is responsible for assessing the cost of deleting or inserting a certain node, in addition to deciding the cost of replacing one node with another. In this implementation, the Core component provides two types of CostAssessors: XMLCostAssessor and RefXMLCostAssessor. Each domain decides which one to use according to whether the domain may include references or not. In this way, the implementation of the invention can distinguish between the approach and the cost function. It is also important to mention that RefXMLCostAssessor is the component that is responsible for assessing the reference structure similarity. Given two nodes x and y, in order to assess the similarity measure, RefXMLCostAssessor checks if:
Neither node has a hyperlink attribute: a regular matching cost assessment is applied either through a domain-specific cost function or by applying a string-edit distance between the element names, attributes, and values.
One node has a hyperlink attribute: a tree-edit distance measure is calculated between the referenced structure on the hyperlink side against the entire sub-tree on the other side.
Both nodes have hyperlink attributes: a tree-edit distance measure is calculated between both referenced structures.

Edit Script backtracker: is an optional module that runs when the tree-edit script is required. In application domains where the edit distance should be accompanied with an edit script, this module is responsible for building the edit script that is associated with the calculated tree-edit distance. A tree-edit traces map is recorded during the distance calculation process. These maps are matrixes where each cell records how the corresponding edit-distance was calculated and which one(s) of three edit choice led to that distance. By doing this, a calculated edit distance can be tracked back to determine the sequence of edit operations involved in such a distance. In cases where multiple edit scripts are possible, this module employs the three-filtration steps of the simplicity heuristics noted above.

Advanced Comparison: this module is responsible for recognizing move operations as a combination of deletion from one place and insertion at another place. This module starts with calling the TreeEditingSuggestor for the two given XML documents in order to recognize deletions, insertions, and change operations. The advanced Comparison Module then strips out the two trees from all nodes except from sub-trees that are entirely deleted or inserted. Then, this module calls TreeEditingSuggestor on the stripped trees trying to find if there are any possible matches. If there are possible matches, these are recognized as moves. If there are no possible matches, they are reported as regular deletions or insertions.

This implementation of the invention may be configured using a number of options and the configuration affects the results obtained. The following options are preferably provided by a domain expert through a configuration file.

Cost function: It can be manually composed, or automatically generated by the implementation of the invention in a bootstrapping step from the domain XSD. A cost model is the module responsible for assessing the cost of various edit-operations such as deleting a node, inserting a node, or changing a node label. A simple cost function would assign the same cost to all operations, with deletions and insertions having the same cost as changes. A better cost-function assigns costs based on the importance of the edit operating on the semantics of the document such that deleting important nodes should be more expensive than deleting optional or less important nodes. The present invention uses a context-oriented cost model where the cost of deleting or inserting a node is determined in the context of other edit operations happening around this node. The description above provides details regarding the context-oriented cost model and the relative weight between the change and deletion (or insertion) edit costs.

Key elements (optional): is a list of schema element names that appear in an XML document. In some domains, a user is not interested in detailed edit operations that may happen to all types of elements. Instead, the domain expert is only interested in changes happening to some particular elements. This configuration option will not affect the calculation process but will be used in the solution report phase to filter out elements that are not key elements. For example, in OWL/RDF the objective is to find mapping between Class DatatypeProperty, and ObjectProperty but not Restriction nor subClassOf, etc. Hence, the elements Class DatatypeProperty, and owl:ObjectProperty should be considered key elements.

Key attributes: this configuration option is used to give the implementation of the invention a hint about the relative importance of some attributes. In other words, attributes specified in this option are given more importance than other types of attributes. For example, since key attributes such as @id, @attribute, etc are relatively more important than values of other attributes, changing or deleting any of these attributes is double the cost of the changing or deleting regular attributes. Similarly, a perfect match between two key attributes is given a double reward compared to matching regular attributes.

Meta Elements: a list of elements such as scripts and comments in HTML, XML instructions and comments, etc. that should not be considered during the differencing process. These elements will be suppressed during the differencing process.

Meta attributes: is a list of attributes, similar to meta elements, such as identifiers used by IDEs, or those used for reverse engineering backward compatibility that are not to be considered during the differencing process.

Reference Structure: the domain expert must decide whether the provided XML documents will include a reference structure, in which case the following two options are to be provided.
ID attributes: a list of attribute names that are used as object IDs. In many cases, this list of attributes overlaps with the list provided as Key attributes.
IDRef attributes: a list of attribute names that will reference, and have hyperlinks to, objects identified by ID attributes.

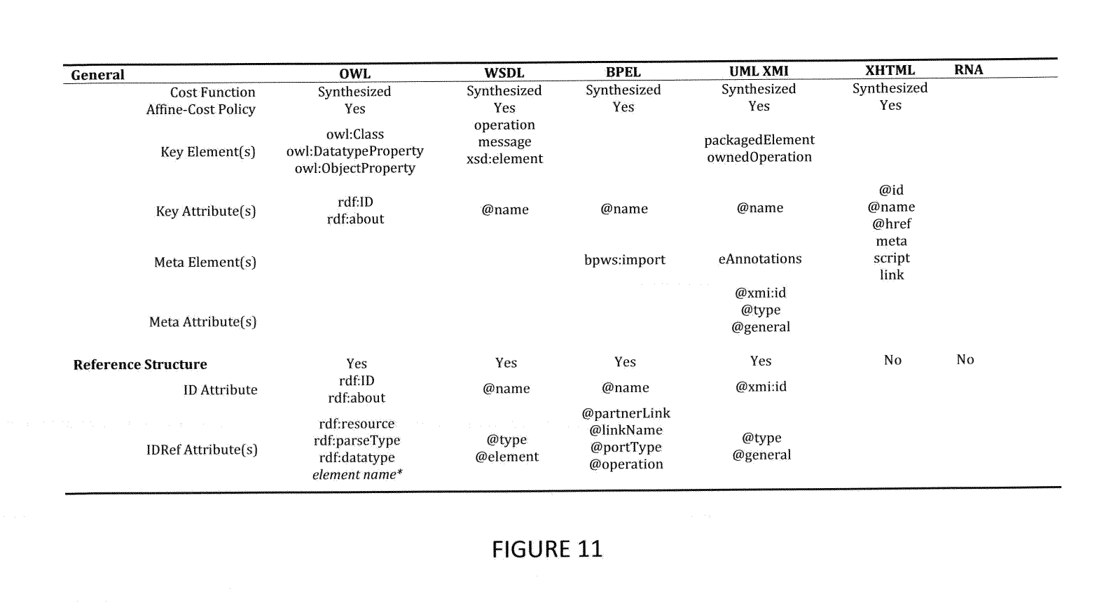

The table in FIG. 11 shows the configuration necessary to customize this implementation for domains of interest. As shown in the table, the process of customizing this implementation of the invention to a certain domain is a simple process.

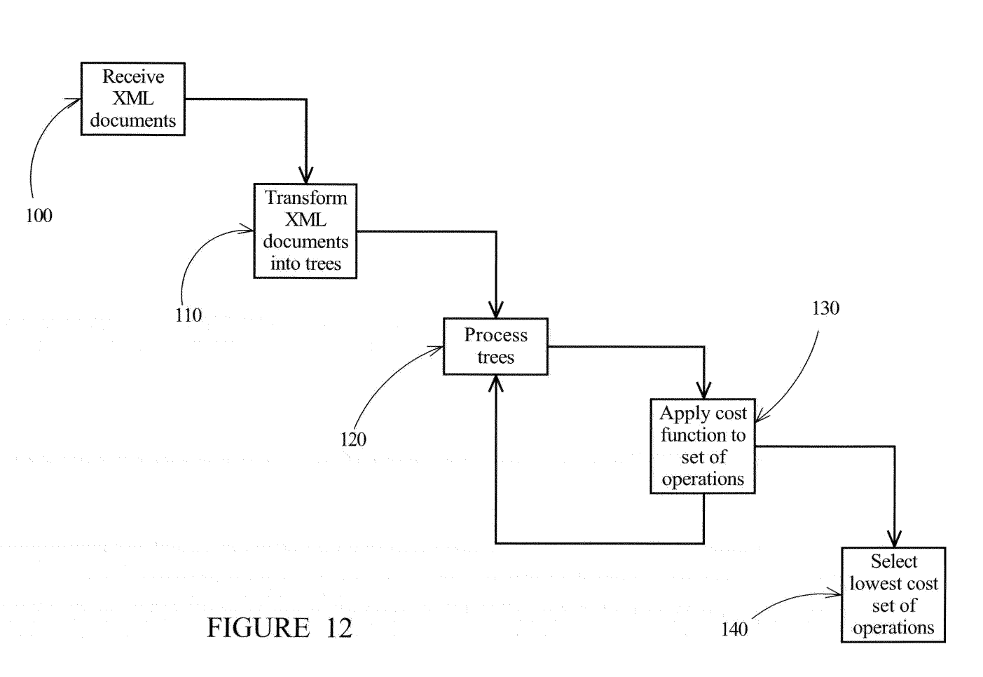

Referring to FIG. 12, a flowchart detailing the steps in a method according to one aspect of the invention is illustrated. The method starts at step 100 with receiving two XML documents for comparison. In step 110, both XML documents are transformed/decomposed or converted into ordered labeled trees. Each tree is then processed (step 120) to arrive at sets of operations which, when applied, converts one tree into the other. This processing step may involve recursive processing which divides a tree into sub-trees. Sub-trees for one tree are then compared to sub-trees for the other tree to determine tree-edit distances (i.e. the cost of converting one tree or sub-tree into another tree or sub-tree). This step (step 130) of determining the cost of converting one tree or sub-tree into another tree or sub-tree uses cost functions that take into account the context of the operations, the references in the tree (i.e. references to other documents), as well as discounts for operations that lower the overall cost of the conversion. If necessary, the processing steps (steps 120 and 130) are repeated to arrive at multiple potential solutions or sets of operation for converting one tree into another. Step 140 then selects which potential solution has the lowest cost after using the cost functions in step 130.

The method steps of the invention may be embodied in sets of executable machine code stored in a variety of formats such as object code or source code. Such code is described generically herein as programming code, or a computer program for simplification. Clearly, the executable machine code may be integrated with the code of other programs, implemented as subroutines, by external program calls or by other techniques as known in the art.

The embodiments of the invention may be executed by a computer processor or similar device programmed in the manner of method steps, or may be executed by an electronic system which is provided with means for executing these steps. Similarly, an electronic memory means such computer diskettes, CD-ROMs, Random Access Memory (RAM), Read Only Memory (ROM) or similar computer software storage media known in the art, may be programmed to execute such method steps. As well, electronic signals representing these method steps may also be transmitted via a communication network.

Embodiments of the invention may be implemented in any conventional computer programming language For example, preferred embodiments may be implemented in a procedural programming language (e.g.“C”) or an object oriented language (e.g.“C++”, “java”, or “C#”). Alternative embodiments of the invention may be implemented as pre-programmed hardware elements, other related components, or as a combination of hardware and software components.

Embodiments can be implemented as a computer program product for use with a computer system. Such implementations may include a series of computer instructions fixed either on a tangible medium, such as a computer readable medium (e.g., a diskette, CD-ROM, ROM, or fixed disk) or transmittable to a computer system, via a modem or other interface device, such as a communications adapter connected to a network over a medium. The medium may be either a tangible medium (e.g., optical or electrical communications lines) or a medium implemented with wireless techniques (e.g., microwave, infrared or other transmission techniques). The series of computer instructions embodies all or part of the functionality previously described herein. Those skilled in the art should appreciate that such computer instructions can be written in a number of programming languages for use with many computer architectures or operating systems. Furthermore, such instructions may be stored in any memory device, such as semiconductor, magnetic, optical or other memory devices, and may be transmitted using any communications technology, such as optical, infrared, microwave, or other transmission technologies. It is expected that such a computer program product may be distributed as a removable medium with accompanying printed or electronic documentation (e.g., shrink wrapped software), preloaded with a computer system (e.g., on system ROM or fixed disk), or distributed from a server over the network (e.g., the Internet or World Wide Web). Of course, some embodiments of the invention may be implemented as a combination of both software (e.g., a computer program product) and hardware. Still other embodiments of the invention may be implemented as entirely hardware, or entirely software (e.g., a computer program product).

A person understanding this invention may now conceive of alternative structures and embodiments or variations of the above all of which are intended to fall within the scope of the invention as defined in the claims that follow.

We claim:

1. A method for determining differences between a first document and a second document, the method comprising:
a) decomposing said first document into an ordered labeled tree to result in a first tree;
b) decomposing said second document into an ordered labeled tree to result in a second tree;
c) determining at least one set of operations which, when executed, converts said first tree into said second tree;
d) providing a cost function for operations used in step c);
e) selecting a set of operations from step c) such that a cost to convert said first tree into said second tree is minimized.

2. A method according to claim 1 wherein step c) further comprises subdividing said trees into sets of sub-trees each identified by a set of key roots, said key roots being nodes which includes a root of said trees and all nodes which have at least one left sibling.

3. A method according to claim 1 wherein said cost function comprises an affine-cost policy which adjusts a cost of each operation based on a context in which said operation is applied.

4. A method according to claim 1 wherein a simplicity-based filter is applied to said at least one set of operations to discard sets of operations which are unlikely.

5. A method according to claim 1 wherein said cost function is an analog function with a range of potential values for each operation.

6. A method according to claim 1 wherein for said cost function, a cost for a deletion of a node is discounted if all of said node's children are likely to be deleted as well.

7. A method according to claim 1 wherein for said cost function, a cost for an insertion of a node is discounted if all of said node's children are likely to be inserted as well.

8. A method according to claim 2 wherein said set of sub-trees is sorted based on which sub-trees have a higher number of inbound references.

9. A method according to claim 2 wherein said set of sub-trees is sorted based on which sub-trees have a higher number of outbound references.

10. A method according to claim 3 wherein a matching cost for converting a first node in a tree to a second node in another tree is determined according to a specific set of criteria, said set of criteria comprising of:
in the event said first node and said second node are a perfect match, then said matching cost is zero;
in the event said first node and said second node are partially similar, said matching cost is prorated to a maximum matching cost such that said matching cost is less than a total cost of deleting said first node and inserting said second node;
in the event said first node and said second node are entirely different, said matching cost is equal to said total cost of deleting said first node and inserting said second node.

11. A method according to claim 1 wherein step e) comprises selecting a set of operations which minimizes a number of operations for converting said first tree into said second tree.

12. A method according to claim 1 wherein step e) comprises selecting a set of operations which minimizes a number of vertical refraction points for said trees.

13. A method according to claim 1 wherein step e) comprises selecting a set of operations which minimizes a number of horizontal refraction points for said trees.

14. Computer readable media having encoded thereon computer readable and computer executable instructions which, when executed implements a method for determining differences between a first document and a second document, the method comprising:
a) decomposing said first document into an ordered labeled tree to result in a first tree;
b) decomposing said second document into an ordered labeled tree to result in a second tree;
c) determining at least one set of operations which, when executed, converts said first tree into said second tree;
d) providing a cost function for operations used in step c);
e) selecting a set of operations from step c) such that a cost to convert said first tree into said second tree is minimized.
